(19) United States
(12) Patent Application Publication
(10) Pub. No.: US 2004/0047156 A1
(43) Pub. Date: Mar. 11, 2004

(54) Foldable circular rope light

(76) Inventor: Tzu-Chen Liu, Taipei (TW)

Correspondence Address: Tzu-Chen Liu, P.O. Box No.6-57, Chung-Ho, Taipei, 235, TW

(21) Appl. No.: 10/237,047

(22) Filed: Sep. 9, 2002

(51) Int. Cl. F21V 21/00

(52) U.S. Cl. 362/391; 362/392; 362/161

(57) ABSTRACT

A foldable circular top light includes two spiral bases, two nuts, a foldable rope light and a plurality of arcuate bodies; the assembly of said members defines a plurality of equidistance rope lights to form a circular and three-dimensional rope light; in addition, transparent decorations clip onto said a plurality of equidistance rope lights thereby increasing the stylish esthetic thereof; furthermore, the present invention is convenient for carrying and occupies less space so as to achieve an effect of being practical and beautiful.

### BACKGROUND OF THE INVENTION

1) Field of the Invention

The present invention relates to a foldable circular rope light, more particularly a structure having a plurality of equidistance rope lights to form a circular and three-dimensional rope light; transparent decorations clip onto said a plurality of equidistance rope lights thereby increasing the stylish esthetic thereof; in addition, the present invention is convenient for carrying and occupies less space so as to achieve an effect of being practical and beautiful.

2) Description of the Prior Art

Accordingly, for about thirty years since the launching of the conventional rope light, the function thereof has been limited to illumination with linear decoration; for example, the writings and patterns on an advertisement signboard or the peripheral decorations on a building are all finished only in a planar, linear or arcuate style, but not designed to be three-dimensional, innovative, have other methods or used for other decorations. Therefore, the inventor of the present invention researched and developed a foldable circular rope light being more practical, having more extensive application scope and complying with the industrial utilization value.

### SUMMARY OF THE INVENTION

Mainly, a head and a tail ends bent at 90 degrees and disposed on a spiral and foldable rope light of the present invention insert respectively into hollow spiral posts of an upper and a lower spiral bases; wherein one end thereof is molded through injection into a power supply joint while the other end is provided for the casing of a light decoration cover molded into various shapes through injection. A proper area on the spiral rope light between the head and tail ends is pressed into a flat shape disposed with a rubber gasket on the outer rim; the central area of the flat shape is disposed with a hole to be respectively inserted into the hollow spiral posts of the upper and lower spiral bases so as to form a circular and three-dimensional rope light assembled by a plurality of equidistance rope lights. Then a plurality of arcuate bodies disposed with transparent decorations thereon clip onto the light tubes of a plurality of equidistance rope lights. Finally, two nuts respectively and correspondingly insert into the hollow spiral posts on the upper and lower spiral bases.

The primary objective of the present invention is to utilize the structural design of the upper and lower spiral bases as well as the foldable rope light to form a circular and three-dimensional structure with the arcuate bodies disposed with the transparent decorations so as to increase the stylish esthetic of the rope light.

The secondary objective of the present invention is to have a structure convenient for carrying and saving storage space thereby achieving an effect of being practical and beautiful.

To enable a further understanding of the objectives, features and the functions of the present invention, the brief description of the drawings below is followed by the detailed description of the preferred embodiment.

### BRIEF DESCRIPTION OF THE DRAWINGS

FIG. 1 is a pictorial drawing of a spiral base and a nut of the present invention.

FIG. 2 is a pictorial drawing of the present invention of a foldable rope light.

FIG. 3 is a status drawing of a partial assembling of the present invention.

FIG. 4 is a status drawing of the entire assembly of the present invention.

FIG. 5 is a drawing of an exemplary embodiment of the present invention.

### DETAILED DESCRIPTION OF THE PREFERRED EMBODIMENTS

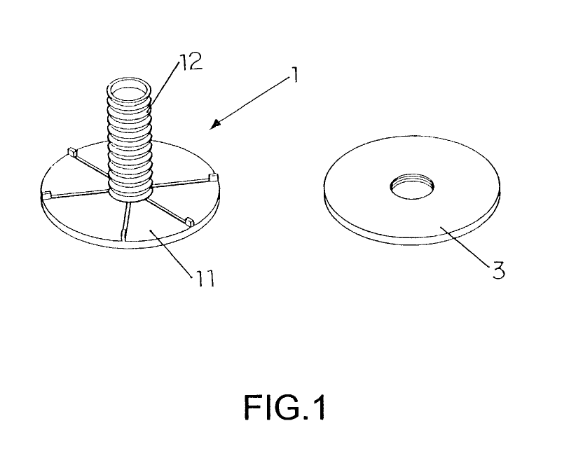

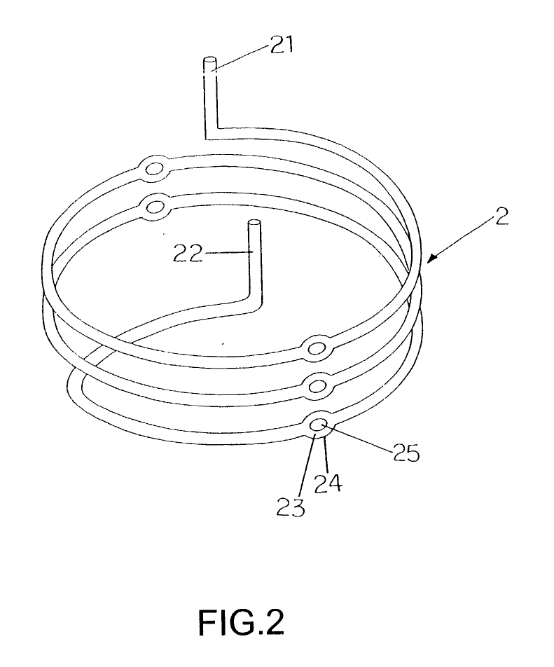

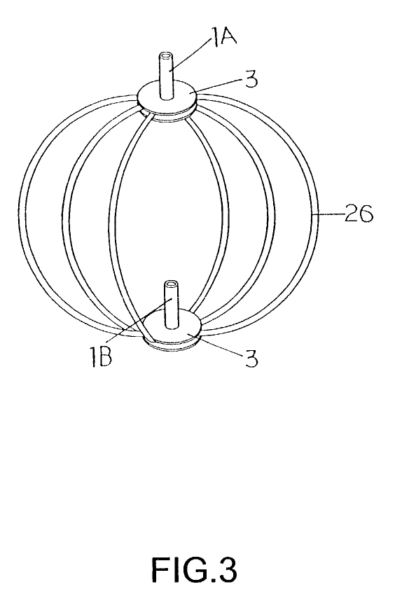

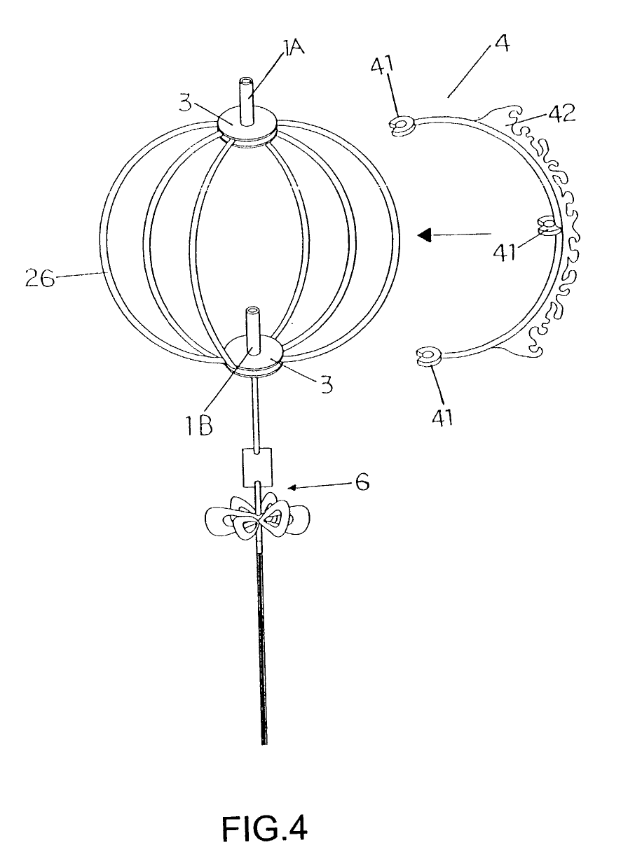

Referring to FIGS. 1, 2, 3 and 4, the present invention comprises two spiral bases (1) divided into an upper spiral base (1A) and a lower spiral base (1B) with circular bottom base (11) thereof; central areas of the bottom bases (11) extend upwardly to have hollow spiral posts (12) provided for the insertion of two ends and two sides of a foldable rope light (2) as well as for two nuts (3) to respectively and correspondingly penetrate for screwing fixedly.

The foldable rope light (2) is in a spiral shape with a head end (21) and a tail end (22) respectively disposed at 90 degrees and inserted into the hollow spiral posts (12) of the upper and lower spiral bases (1A, 1B); wherein one end thereof is molded into a power supply joint through injection while the other end is provided for the casing of light decoration covers (41) molded into various shapes through injection. Proper areas of the spiral rope light (2) between the head and tail ends (21, 22) are pressed into flat shapes (23). Rubber gaskets (24) are disposed on outer rims of two sides of the flat shape (23) for preventing water immersion. A central area of the flat shape (23) is disposed with a hole (25). Two sides of the spiral rope light (2) are respectively inserted into the hollow spiral posts (12) of the upper and lower spiral bases (1A, 1B) thereby forming a circular and three-dimensional rope light assembled by a plurality of equidistance rope lights (26).

Clips (41) are respectively disposed at proper upper, medium and lower areas on said a plurality of arcuate bodies (4) for clipping onto said a plurality of equidistance rope light tubes (26); in addition, the outer rims of the arcuate bodies are disposed with transparent decorations (42) for increasing the stylish esthetic of the rope light (2).

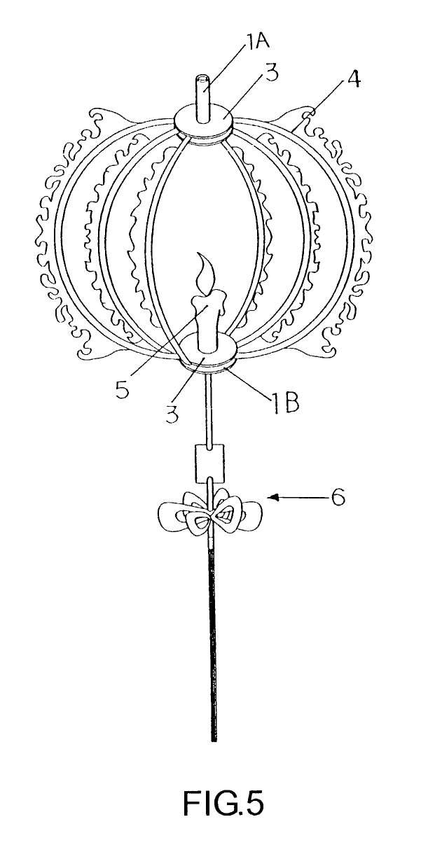

According to the abovementioned, the light decoration covers (5) are made of transparent material and in the shapes of candles, fruits, animals and plants. Under the bottom portion of the lower spiral base (1B), a Chinese knot (6) or other decoration is disposed to set off the artistic beauty of the entire body, as shown in FIG. 5.

According to the abovementioned, when installing the present invention, first the head and tail ends (21, 22), bent at 90 degrees, of the foldable rope light (2) insert respectively into the hollow posts (12) of the upper and lower spiral bases (1A, 1B). Then the proper areas of the spiral rope light (2) between the head and tail ends (21, 22) are pressed into flat shapes. After that, the holes (25) on one side disposed at the central areas of the flat shapes (23) are inserted into the hollow spiral post (12) on the upper spiral base (1A); the holes (25) on the other side are inserted into the hollow spiral post (12) on the lower spiral base (1B) so as to form a circular and three-dimensional structure assembled by a plurality of equidistance rope light tubes (26). Then a plurality of arcuate bodies (4) disposed with a plurality of transparent decorations (42) on the outer rims thereof are clipped onto said a plurality of arcuate light tubes (26) by the clips (41) on the upper, medium and lower portions thereof. Then two nuts (3) insert respectively and correspondingly into the upper and lower spiral bases (1A, 1B) for screwing fixedly. Finally, the light decoration cover (5) in any shape and made of transparent material is cased onto the hollow spiral post (12) on the lower spiral base (1B). In addition, the Chinese knot (6) or other decoration is disposed under the bottom portion of the lower spiral base (1B).

According to the abovementioned, when trying to disassemble the present invention, the light decoration cover (5), the Chinese knot (6) or other decoration are removed first; then the nuts (3), the arcuate bodies (4), the foldable rope light (2), the upper and lower spiral bases (1A, 1B) are detached sequentially. Finally, said members are packed into a box for convenient carrying so as to not occupy substantial storage space but specifically achieve the effect of being practical and beautiful.

In summation of the abovementioned, the present invention of a foldable circular rope light formed as a circular and three-dimensional rope light by assembling a plurality of equidistance rope lights is not previously disclosed. Furthermore, the transparent light decoration covers in various shapes disposed therein, the Chinese knot or other decorations disposed thereunder, the arcuate and transparent bodies disposed on the outer rims thereof to increase the stylish esthetic of the rope light have not been designed previously. In addition, the present invention is convenient for carrying and occupies less space such that the present invention is more practical and beautiful than the conventional rope light.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A foldable circular rope light comprises:
two spiral bases divided as an upper spiral base and a lower spiral base; the bottom bases of the upper and lower spiral base are in circular shapes; central area of the bottom bases extend to form hollow spiral posts provided for two ends and two sides of a foldable rope light to insert respectively and for two nuts to respectively and correspondingly insert for screwing fixedly;
a foldable rope light is in a spiral shape with a head end and a tail end respectively disposed at 90 degrees and inserted into the hollow spiral posts of the upper and lower spiral bases; wherein one end thereof is molded into a power supply joint through injection while the other end is provided for the casing of light decoration covers molded into various shapes through injection; proper areas of the spiral rope light between the head and tail ends are pressed into flat shapes; rubber gaskets are disposed on outer rims of two sides of the flat shape for preventing water immersion; a central area of the flat shape is disposed with a hole; two sides of the spiral rope light are respectively inserted into the hollow spiral posts of the upper and lower spiral bases thereby forming a circular and three-dimensional rope light assembled by a plurality of equidistance rope lights;
clips are respectively disposed at proper upper, medium and lower areas on said a plurality of arcuate bodies for clipping onto said a plurality of equidistance rope light tubes; in addition, the outer rims of the arcuate bodies are disposed with transparent decorations for increasing the stylish esthetic of the rope light.

2. The foldable circular rope light according to claim 1, wherein the light decoration cover is made of transparent material.

3. The foldable circular rope light according to claim 1, wherein the Chinese or various decorations are disposed under the bottom portion of the lower spiral base for setting off artistic beauty of the entire body.
